(19) United States
(12) Patent Application Publication
(10) Pub. No.: US 2012/0160661 A1
(43) Pub. Date: Jun. 28, 2012

(54) Technology - Production of "M-Hydrogen" - alternate source of energy

(76) Inventor: SUBHENDU MOULIK, Singapore (SG)

(21) Appl. No.: 13/135,053

(22) Filed: Mar. 31, 2011

(51) Int. Cl. C01B 3/06; C01B 13/02; C07F 3/02

(52) U.S. Cl. 204/157.5; 540/145

(57) ABSTRACT

This patent covers a chemical process technology. This subject technology is about production of M-Hydrogen from water, using special catalyst in presence of sunlight.

The hydrogen will be used for power generation, using hydrogen cells.

Present hydrogen production technologies produce CO, CO2, NOX gases along with Hydrogen as byproducts. These gases are not environment friendly and injurious to human health.

This patent chemical process is very different from presently available hydrogen production technologies. No similar harmful gases will be generated. Oxygen will be generated as a byproduct which will restore the environmental balance.

### CHAPTER-1—TECHNOLOGY

### 1.1 Technology

This technology resembles the photo synthesis of green plants to split water (H2O) into hydrogen and oxygen using Sun light.

In this process, Hydrogen (H2) will be separated from oxygen (O2) in the presence of a M-Catalyst and will be further purified by the distillation method. This purified Hydrogen (H2) will be stored and used in hydrogen cells to produce electrical energy. Oxygen will be released into the atmosphere.

### CHAPTER-2—M-HYDROGEN

### 2.1 What is M-Hydrogen?

M-Hydrogen is the hydrogen (H2) produced from water in a chemical process using sun light.

2.2 Why is M-Hydrogen Necessary? What Other Technologies are Available to Produce Hydrogen and their Drawbacks?

To support modern civilization, we need lots of electric energy. Energy experts—whatever they say, ultimately have to agree with the eventual depletion of fossil fuels—are predicting that within decades the world will switch to a utopian hydrogen economy, where energy will be abundant, inexpensive and nonpolluting.

M-Hydrogen is used by fuel cells to generate electricity without generating those nasty greenhouse gases.

Using present technology, hydrogen can be extracted from
Fossil fuels
Split Water molecule

The technology, which uses Fossil fuel to produce Hydrogen, is more expensive than directly using oil or natural gas. This method is only a temporary fix. Moreover, apart from Hydrogen, this technology produces greenhouse gases and pollutants together with electricity.

The technology which splits the Water molecule directly uses the electrolysis method. The technology requires electricity generated from fossil fuels or from renewable sources such as wind or solar and is even more expensive than the extraction method.

The M-Hydrogen technology, covered under this patent is the ideal one, because:

This produces
Hydrogen—Good to produce Electricity
Hydrogen—Good to power a Car
Oxygen—Supports our life, saver of nature and civilization

This does not produce

C02—Harmful for health and cause global warming

M-Hydrogen technology is cheaper, take less time for installation of a new plant and production cost/unit of electricity is 1/10 of the present other processes.

### CHAPTER-3—PHOTO SYNTHESIS

### 3.1 Basic Theory of Photo Synthesis

Chlorophyl is a green pigment found in all plants. Chlorophyll absorbs light. Chlorophyl is vital for photosynthesis, which allows plants to obtain energy from light.

### 3.2 Structure of Chloroplast

Chlorophyl molecules are specifically arranged in and around photo systems that are embedded in the “thylakoid” membranes of chloroplast.

### 3.3 Hydrogen Generation

Chlorophyl molecules perform the following functions

1. Absorb light

2. Transfer light energy by resonance energy transfer to a specific chlorophyll pair in the reaction center of the photo system

3. The function of the reaction center chlorophyl is to use the energy absorbed by and transfer to it from the other chlorophyll pigments in the photo systems to undergo charge separation, a specific “Redox” reaction, in which the chlorophyl donates an electron into a series of molecular intermediates, called an electron transport chain. The charged reaction center chlorophyl is then reduced back to its ground state by accepting an electron.

4. This electron comes from oxidation of water (H2O) molecule into O2 and H2.

### CHAPTER 4

### Proposed Design and Technology of the M-Hydrogen Generation Plant

### 4.1 Raw Material

This process uses Potable water as raw material. Potable water is filtered for any foreign particle and stored in an intermediary tank. Water quality has to follow EPA norms.

The chemical property of this water is minimum to be as follows

pH=2.5 to 8.5

LSI Index<=0

Conductivity=1-100 μS/cm

Potable water is heated up to the optimum design temperature T(D_Water_temp_DegC.) and pumped into reactor through bottom nozzle.

### 4.2 Process

The reactor is made up of Special Glass material, transparent and has anti acid and base properties. This reactor consists of three Catalysts beds separated by special membrane.

The hydrogen and water vapor from top nozzle of the reactor is connected to another reactor through Middle section of catalyst. Number of reactors in a power plant depends on the capacity of the power plant and hydrogen requirement.

Every reactor has a water inlet from a bottom nozzle, it has level control, temperature control and standard safety feature of high pressure trip logic control.

The hydrogen and water vapor is connected to a common header through the top nozzle which transfers the Hydrogen gas from the Reactor to a hydrogen distillation system where hydrogen is distilled to 99.99% purity or otherwise as per requirement of the relevant hydrogen cell.

The reactor has an electric stabilized Earthing system.

### 4.3 Metallurgy

The general piping systems consists of Seamless Steel pipe of A106 Gr B. Reactor connected sections have a special spool to be connected to carbon steel material.

### CHAPTER 5

### 5.1 Metallurgy of M-Catalyst

It is a heterocyclic aromatic ring consisting at the core of three pyrroles and one pyrroline couples through four methine linkages. At the centre of this ring is a magnesium ion. This ring can have several side chains.

### CHAPTER 6

### 6.1 What is M-Hydrogen Power Plant?

An M-hydrogen power plant is a concept design for a new widespread source of electricity. Essentially, it is a facility which uses M-hydrogen to produce electrical energy.

### 6.2 How Does a Hydrogen Power Plant Work?

Large tanks of liquid hydrogen will feed into thousands of hydrogen fuel cells. These fuel cells are solid structures, containing an electrolyte fluid and two terminals, much like batteries. The reactants flow into the cells, in this case hydrogen and oxygen. They intermingle with the electrolyte to produce an electrical charge and water as a byproduct. The water flows out another port while the electricity is siphoned off the terminals and held in gigantic multi-ton batteries. The electricity resides in the batteries until it is needed, in which case it is sent out through the local power grid just like any other type of power plant. In theory, this could be a near perfect source of energy as it has no dangerous byproducts and is just as fuel-efficient as the average internal combustion engine.

1. Procedure for Breaking H2O to H2 and O2 using sun light.

2. Scientific details and Engineering design for the procedure for Breaking H2O to H2 and O2 using sun light.

3. M-Catalyst—it's metallurgical details, physical and chemical properties
